(19) United States
(12) Patent Application Publication
(10) Pub. No.: US 2017/0373396 A1
(43) Pub. Date: Dec. 28, 2017

(54) COIL DEVICE AND ELECTRONIC DEVICE

(71) Applicant: Murata Manufacturing Co., Ltd., Nagaokakyo-shi (JP)

(72) Inventors: NOBORU KATO, Nagaokakyo-shi (JP); Masahiro Ozawa, Nagaokakyo-shi (JP)

(21) Appl. No.: 15/697,663

(22) Filed: Sep. 7, 2017

Related U.S. Application Data
(63) Continuation of application No. PCT/JP2016/056088, filed on Feb. 29, 2016.

(30) Foreign Application Priority Data
Mar. 9, 2015 (JP) 2015-046119

(51) Int. Cl. H01Q 7/08; H01F 27/00; H01F 27/28; H01Q 1/24; H01F 17/04; H01F 27/34; H01F 17/00

(52) U.S. Cl. CPC H01Q 7/08; H01Q 1/24; H01F 27/006; H01F 17/04; H01F 27/28; H01F 17/045; H01F 17/0013; H01F 27/34

(57) ABSTRACT

A coil device has a plate-like element body having a main surface, a back surface, and an end surface, a helical coil provided in the element body and having a coil axis extending between the main surface and the back surface, and a connection terminal provided on the back surface or the end surface of the element body and connected to the helical coil. As for a conductor constituting the helical coil, a plurality of conductor portions extending along the main surface are comprised of a plurality of metal pins, respectively.

### CROSS REFERENCE TO RELATED APPLICATION

The present application is a continuation of International application No. PCT/JP2016/056088, filed Feb. 29, 2016, which claims priority to Japanese Patent Application No. 2015-046119, filed Mar. 9, 2015, the entire contents of each of which are incorporated herein by reference.

### TECHNICAL FIELD

The present invention relates to a coil device and an electronic device having the coil device.

### BACKGROUND ART THE INVENTION

Helical coils, such as the coil device disclosed in Unexamined Japanese Patent Publication No. 2005-26384 or 2009-289995, are known. In these disclosed structures the helical coil is mounted on a circuit substrate and made of wire.

This structure is disadvantageous because the distance between adjacent conductors can vary due to a change in shape of the wire. These changes cause a variation in magnetic field distribution generated by the helical coil and there is a variation in its inductance value. When this coil conductor is used in a wireless communication device as an antenna, variations in the magnetic field distribution of the helical coil result in a variation of the communicating distance of the coil. Therefore, the communication distance can vary with a production lot and a tuning element is needed to correct a variation in resonant frequency of the antenna. One object of the present invention is to provide a helical coil which suppresses these variations in magnetic field distribution and inductance values.

### BRIEF DESCRIPTION OF THE INVENTION

In one aspect of the invention, a coil device comprises:

a plate-like element body having a main surface, a back surface, and an end surface;

a helical coil having a coil axis extending between the main surface and the back surface of the element body, the helical coil including a first plurality of conductive portions located in the element body and arranged at spaced locations along the coil axis, each of the first plurality of conductive portions being a conductive pin; and

a connection terminal provided on at least one of the back surface and the end surface of the element body and connected to the helical coil.

The helical coil can further comprise a second plurality of conductive portions, the first plurality of conductive portions lying in a first plane and the second plurality of conductive portions lying in a second plane spaced from the first plane. Each of the second plurality of conductive portions is a preferably conductive pin. The first and second planes are preferably parallel to one another and the main and back surfaces of the element body.

In one aspect of the invention, the first plurality of conductive portions are spaced apart from each other by a first distance as measured along the coil axis and the second plurality of conductive portions are spaced apart from each other by a second distance as measured along the coil axis, the first and second distances being different than each other. Preferably the first distance is smaller than the second distance.

In another aspect of the invention, each of the conductive portions of the first and second plurality of conductive portions are circular in cross-section.

In another aspect of the invention, the conductive portions of the first plurality of conductive portions have a larger diameter than the conductive portions of the second plurality of conductive portions.

In accordance with a further aspect of the invention, the first plurality of conductive portions lie in a plane that is parallel to the coil axis and include first and second outer conductive portions with the remaining conductive portions of the first plurality of conductive portions being located between the first and second outer conductive portions. The second plurality of conductive portions also lie in a plane that is parallel to the coil axis and include third and fourth outer conductive portions with the remaining conductive portions of the second plurality of conductive portions being located between the third and fourth outer conductive portions. The distance between the first and second outer conductive portions, as measured along the coil axis, is less than the distance between the third and fourth outer conductive portions as measured along the coil axis.

In yet another aspect of the invention, each conductive portion of the second plurality of conductive portions is located closer to the back surface of the element body than to the main surface of the element body and each of the conductive portions of the first plurality of conductive portions is located closer to the main surface of the element body than to the back surface of the element body. The second plurality of conductive portions include first and second outer conductive portions, the remaining conductive portions of the second plurality of conductive portions being located between the first and second outer conductive portions, at least a portion of the first and second outer conductive portions being exposed at the back side of the element body and acting as a connection terminal portion. In a preferred embodiment, the first and second conductive portions are semicircular in cross-section and the remaining conductive portions of the second plurality of conductive portions are circular in cross-section. More preferably, the remaining conductive portions of the second plurality of conductive portions are metal pins.

In a further aspect of the invention, the second plurality of conductive portions are located on the back surface of the element body and have a rectangular cross-section.

In another aspect of the invention, coil device includes a magnetic body disposed in the helical coil.

In some embodiments the helical coil includes conductive connecting portions which connect pins of the first plurality of conductive portions to the conductive portions of the second plurality of conductive portions, the conductive connecting portions being located on the end surface of the element body.

The invention is also directed towards a wireless communication device including the forgoing coil device and a circuit substrate having at least one wiring pattern, the coil device being mounted on the circuit substrate and being electrically coupled to the wiring pattern either the back surface or the end surface of the element body. The coil device is preferably electrically coupled to the wiring pattern via at last one connection terminal located on the back surface of the element body.

### BRIEF DESCRIPTION OF THE DRAWINGS

FIG. 1 is a partial schematic perspective view of a wireless communication device having a coil device as an antenna in an embodiment 1 of the present invention.

FIG. 2 is a perspective view showing an inside of the coil device in the embodiment 1.

FIG. 3 is a cross-sectional view taken along a line Q-Q in FIG. 2.

FIG. 4 is a view showing a magnetic field distribution generated by the coil device.

FIG. 5A is a view to explain a step in one example of a method for manufacturing the coil device in the embodiment 1.

FIG. 5B is a view to explain a step subsequent to the step in FIG. 5A.

FIG. 5C is a view to explain a step subsequent to the step in FIG. 5B.

FIG. 5D is a view to explain a step subsequent to the step in FIG. 5C.

FIG. 5E is a view to explain a step subsequent to the step in FIG. 5D.

FIG. 6 is a partial cross-sectional view of a wireless communication device having a coil device as an antenna in an embodiment 2 of the present invention.

FIG. 7 is a partial cross-sectional view of a wireless communication device having a coil device as an antenna in an embodiment 3 of the present invention.

FIG. 8 is a partial cross-sectional view of a wireless communication device having a coil device as an antenna in an embodiment 4 of the present invention.

FIG. 9 is a partial schematic perspective view of a wireless communication device having a coil device as an antenna in an embodiment 5 of the present invention.

FIG. 10 is a view to explain a step in one example of a method for manufacturing the coil device in the embodiment 5.

FIG. 11 is a partial side view of a wireless communication device having a coil device as an antenna in an embodiment 6 of the present invention.

FIG. 12 is a perspective view of a wireless communication device having a coil device as an antenna in an embodiment 7 of the present invention.

FIG. 13 is a cross-sectional view of the wireless communication device in the embodiment 7.

FIG. 14 is an exploded perspective view of a booster antenna.

FIG. 15 is a circuit diagram of the booster antenna.

FIG. 16 is a perspective view of a coil device in an embodiment 8 of the present invention.

FIG. 17 is a view to explain a step in one example of a method for manufacturing the coil device in the embodiment 8.

FIG. 18 is an exploded perspective view of a wireless communication device having a coil device as an antenna in an embodiment 9 of the present invention.

FIG. 19 is a circuit diagram of the wireless communication device in the embodiment 9.

FIG. 20 is an exploded perspective view of a wireless communication device having a surface mount coil as an antenna in an embodiment 10 of the present invention.

FIG. 21 is a circuit diagram of the wireless communication device in the embodiment 10.

FIG. 22 is an exploded perspective view of a DC-DC converter device having a coil device as a choke coil in an embodiment 11.

FIG. 23 is a circuit diagram of a DC-DC converter module in the embodiment 11.

FIG. 24 is an exploded perspective view of a wireless communication device having a coil device as an antenna in an embodiment 12.

FIG. 25 is an exploded perspective view of a wireless communication device having a coil device as an antenna in an embodiment 13.

### Embodiment 1

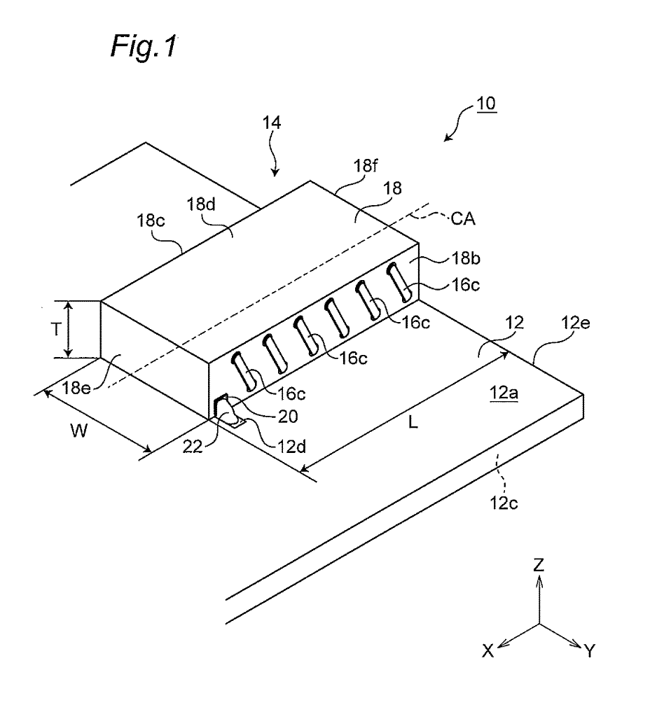

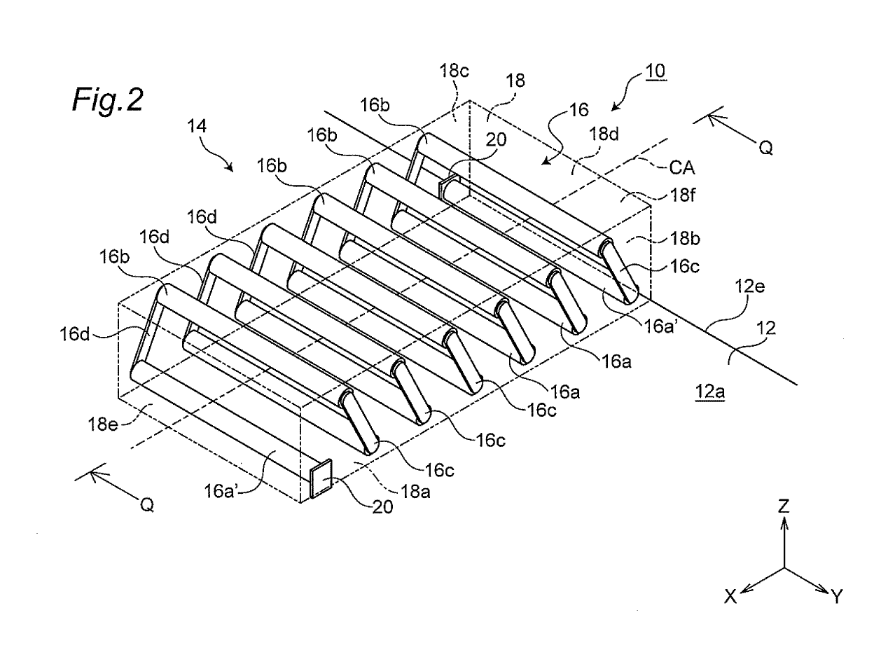

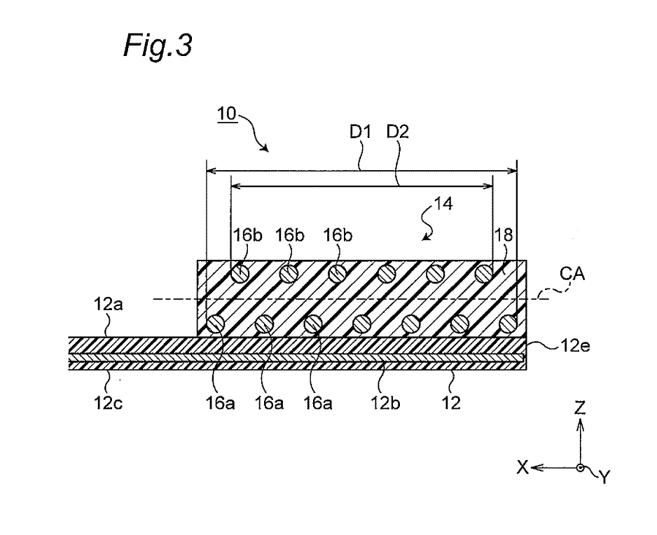

FIG. 1 is a view schematically showing a wireless communication device serving as one example of an electronic device having a coil device as an antenna in the embodiment 1 of the present invention. FIG. 2 is a perspective view showing an inside of the coil device. FIG. 3 is a cross-sectional view taken along a line Q-Q in FIG. 2. In the above drawings, an X-Y-Z orthogonal coordinate system, and a s-t-u orthogonal coordinate system are shown, but these are provided to easily understand the embodiments of the present invention and do not limit the present invention.

In this embodiment, and as shown in FIG. 1, the wireless communication device 10 has a circuit substrate 12 and a coil device 14, which serves as an antenna and is mounted on a main surface 12a of the circuit substrate 12. The coil device 14 is shown as having a cuboidal shape (block shape) in the drawing for ease of illustration, but preferably has a plate-like shape which is as thin as possible. That is, it has a chip-like shape in its length L, as measured along the X axis extending along the axis CA of the helical coil 16 formed in the helical device 14, and its width W, as measured along the Y direction perpendicular to the axis CA and are greater than its thickness T as measured along the Z direction. In this embodiment, the coil device 14 is preferably an antenna element which has a carrier frequency in a HF band and is used, for example, in a NFC (Near Field Communication) system.

The circuit substrate 12 is preferably a mother substrate such as printed wiring board and has a wiring pattern (not shown) made of conductive material (such as copper material) on the main surface 12a for mounting the coil device 14. The circuit substrate 12 preferably has an RFIC chip and a surface mount type capacitor on its main surface 12a and these components are connected to the coil device 14 through the wiring pattern. Furthermore, as shown in FIG. 3, the circuit substrate 12 preferably has an internal conductive ground layer 12b. Alternatively, the ground layer 12b may be provided on a back surface 12c of the circuit substrate 12 as a ground pattern. The ground layer 12b is preferably formed along almost the entirety of the circuit substrate 12.

As shown in FIG. 2, the coil device 14 has a helical coil 16 and a plate-like binder member (element body) 18 having a mount surface (back surface) 18a which faces the main surface 12a of the circuit substrate 12, a top surface (main surface) 18d opposing the mount surface 18a, two end surfaces 18e and 18f intersecting the coil axis CA and end surfaces 18b and 18c extending parallel to the coil axis CA. The mount surface 18a serves as the mount surface when the coil device is mounted on the mother substrate. The mount surface 18a and the top surface 18d are preferably larger in area than the end surfaces 18b, 18c, 18e and 18f. That is, the element body 18 is formed into a plate-like shape (thin plate-like shape) in which its thickness T is smaller than its length L and its width W. In this embodiment, the area of its end surfaces 18b and 18c are larger than the areas of its end surfaces 18e and 18f However, the end surfaces 18e and 18f may be larger in area than the end surfaces 18b and 18c.

As shown in FIG. 1, the coil axis CA of the helical coil 16 extends between the mount surface 18a and the top surface 18d of the element body 18 parallel to the main surface 12 of the circuit substrate. However, the invention is not limited to this arrangement and the coil axis CA and the plane of the main surface 18 need not be parallel to one another.

As shown in FIG. 2, the helical coil 16 is composed of first to fourth sets of pluralities of conductors 16a to 16d. More specifically, as shown in FIG. 2, the plurality of second conductors 16a are arranged at regular intervals along the coil axis CA (the X-axis direction) at a position closer to the mount surface 18a than the top surface 18d. In this embodiment 1, the plurality of second conductors 16a are arranged parallel to each other in a common plane and each of them is composed of a respective metal pin extending parallel to the mount surface 18a (that is, the circuit substrate 12) (in the Y-axis direction) and having a circular cross-section. The metal pin is preferably a columnar metal member made of, for example, copper material. Furthermore, the diameter of the circular cross-section of the metal pin is, for example, 30 μm to 1 mm.

A plurality of first conductors 16b are arranged at regular intervals along the coil axis at a position closer to the top surface 18d of the element body 18 than the plurality of second conductors 16a and are therefore further from the main surface 12a of the circuit substrate 12 than the plurality of second conductors 16a. In embodiment 1, the plurality of first conductors 16b are located in a common plane and are spaced from and extend parallel to each other and each of them is preferably composed of a metal pin extending parallel to the Y-axis direction and having a circular cross-section. The metal pin is preferably a columnar metal member made of, for example, copper material. The diameter of the circular cross-section surface of the metal pin is, for example, 30 μm to 1 mm. In embodiment 1, the plurality of first conductors 16a and the plurality of first conductors 16b are preferably composed of the same metal pins. Thus, compared with a case where the first conductor 16a and the second conductor 16b are composed of different metal pins, a manufacture cost of the coil device 14 can be reduced.

Each of a plurality of third conductors 16c is located on the side surface 18b of the element body 18 and connects one end of a respective first conductor 16a to one end of a respective first conductor 16b. Each of the plurality of fourth conductors 16d is located on the side surface 18c of the element body and connects one end of a respective second conductor 16a to one end of a respective first conductor 16b.

The plurality of first and second conductors 16b and 16a are located inside of the element body 18. The element body 18 preferably has the plate-like shape and is preferably made of resin material such as epoxy resin. Because the plurality of second conductors 16a are located internally of the element body 18, they are stably arranged at regular intervals along the direction of the coil axis CA (the X-axis direction). Similarly, the plurality of first conductors 16b are stably arranged at regular intervals along the direction of the coil axis CA.

As noted above, the plurality of third and fourth conductors 16c and 16d are respectively provided on the end surfaces 18b and 18c of the element body 18 and are preferably composed of conductive patterns formed on the end surfaces 18b and 18c of the element body 18.

The end surfaces 18b and 18c of the element body 18 have respective connection terminals 20, each of which is electrically connected to a respective terminal 12d (one of which is shown in FIG. 1) on the main surface 12a of the circuit substrate 12 through a conductive bonding material 22 such as solder. Each of the connection terminals 20 is connected to a respective end (this end is not connected to the third conductor 16c and the fourth conductor 16d) of one of the second conductors 16a′ provided at opposite ends of the plurality of first conductors 16a in the extending direction of the coil axis CA (X-axis direction). See FIG. 2. That is, one connection terminal 20 is connected to one terminal of the helical coil 16, while the other connection terminal 20 is connected to the other terminal of the helical coil 16.

The coil device 14 having the helical coil 16 is preferably mounted at or near an end (edge) of the main surface 12a of the circuit substrate 12 so that one axial coil opening of the helical coil 16 faces inwardly of the circuit substrate 12 while the other faces outwardly of the circuit substrate 12. In embodiment 1, the coil device 14 is mounted on the main surface 12a of the circuit substrate 12 such that the coil axis CA of the helical coil 16 intersects with a side between the main surface 12a and an end surface 12e (an end surface in the X-axis direction) of the circuit substrate 12.

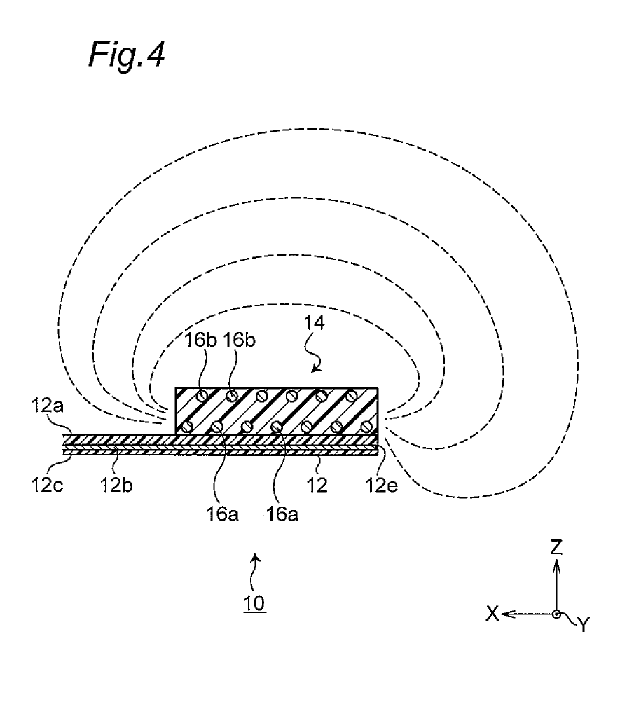

As shown in FIG. 4, when the coil device 14 is disposed as described above, a magnetic field (broken lines) generated from the helical coil 16 expands upwardly from the main surface 12a of the circuit substrate 12. At the same time, the magnetic field expands outwardly away from the end surface 12e. As a result, the magnetic field from the helical coil 16 is not easily canceled by the ground layer 12b. Thus, compared with a case where the coil device 14 is provided on a center of the main surface 12a of the circuit substrate 12, a communicatable range of the wireless communication device 10 can be enlarged and a communication distance thereof can be increased.

As shown in FIG. 4, the magnetic field generated from the helical coil 16 of the coil device 14 is blocked by the ground layer 12b in the circuit substrate 12 and by the wiring pattern (not shown) on the main surface 12a, so that it hardly expands toward the back surface 12c of the circuit substrate 12. That is, the communication distance can be increased by using a metal body such as the ground layer provided in the circuit substrate 12.

Hereinafter, one example of a method for manufacturing the coil device 14 in the embodiment 1 will be described.

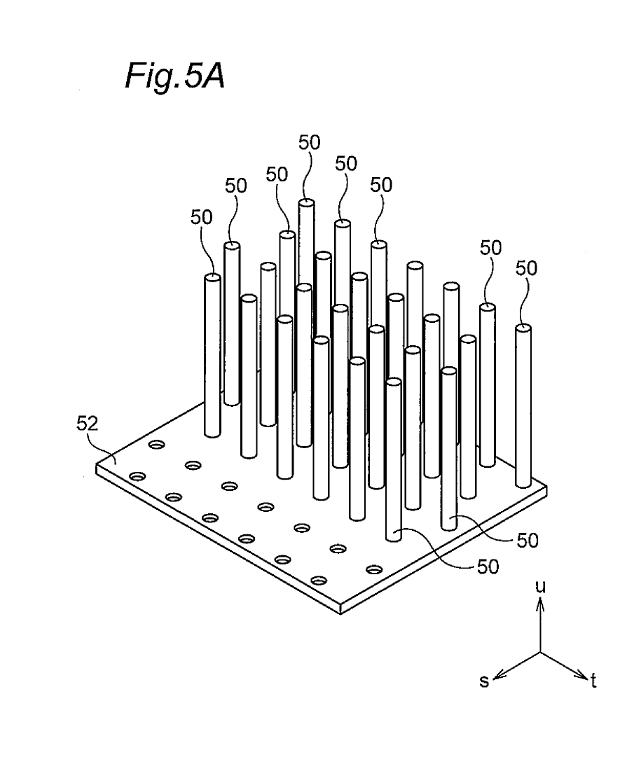

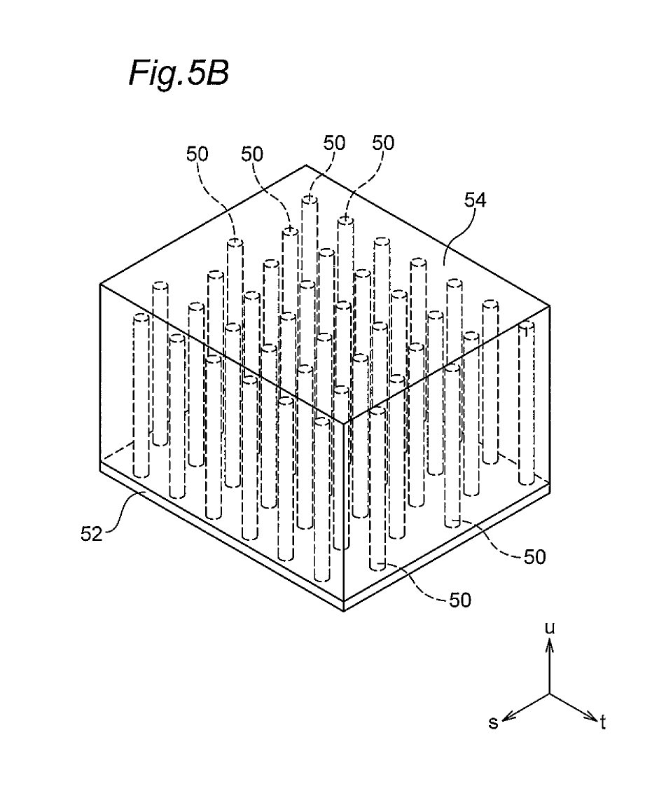

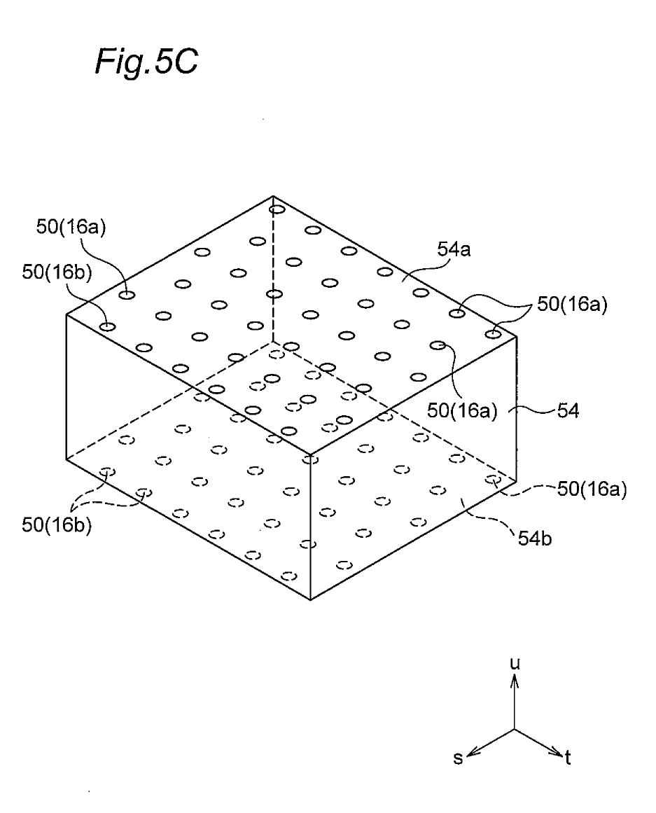

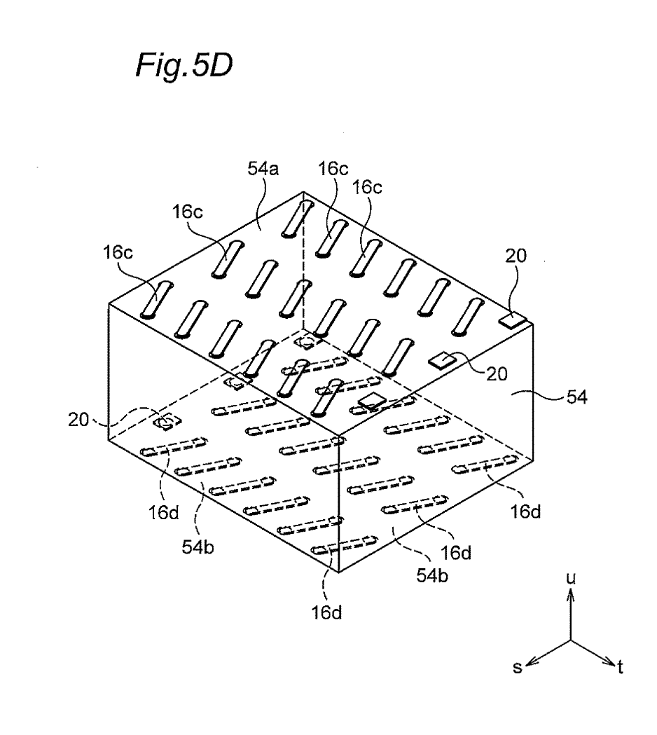

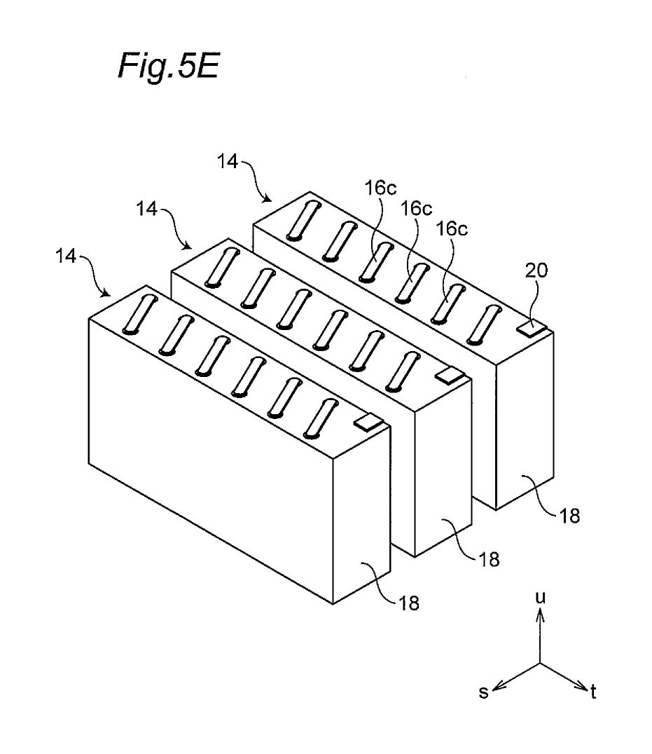

First, as shown in FIG. 5A, a plurality of metal pins 50 having the same shape are set in a pin stand 52 so as to be arranged in rows in a direction (t-axis direction) perpendicular to a longitudinal direction (u-axis direction) of the metal pins. Each metal pin 50 may be fixed in the pin stand 52 with a bonding agent such as epoxy resin.

After that, as shown in FIG. 5B, a resin block 54 is formed on the pin stand 52 so as to internally contain the plurality of metal pins 50. The resin block 54 is preferably formed by pouring an uncured resin onto the pin stand 52 and heat curing the resin.

Subsequently, as shown in FIG. 5C, upper and lower sides of the resin block 54 (as viewed in FIG. 5c) are polished so that opposite ends of the metal pins 50 in the longitudinal direction (u-axis direction in FIG. 5c) are exposed from the resin block 54. Thus, the upper and lower surfaces are planarized and the ends of the metal pins are exposed, whereby the plurality of second conductors 16a and the plurality of first conductors 16b are manufactured so as to be internally contained in the resin block 54. In FIG. 5C, the metal pins 50 are not shown for the sake of simplification, and only the exposed end surfaces are shown.

Subsequently, as shown in FIG. 5D, the plurality of third conductors 16c and at least one connection terminal 20 are patterned and formed on the polished surface 54a of the resin block 54. Similarly, the plurality of fourth conductors 16d and at least one connection terminal 20 are patterned and formed on the other polished surface 54b of the resin block 54. For example, the third conductors 16c, the fourth conductors 16d, and the connection terminals 20 are formed as metal layers (such as copper layers) on the polished surfaces 54a and 54b of the resin block 54 and then the metal layers are patterned by photo-etching. Alternatively, they are formed such that conductive paste is formed into a predetermined pattern by screen printing and then subjected to a heat treatment. After the patterning, the surface of the metal layer may be plated with, for example, nickel-gold or tin.

Then, as shown in FIG. 5E, the resin block 54, including the third conductors 16c, the fourth conductors 16d, and the connection terminals 20, is cut into a plurality of individual parts, whereby the plurality of coil devices 14 are manufactured.

According to embodiment 1, most of the helical coil 16 (more particularly the first and second conductors 16b, 16a) are composed of the metal pins which are more rigid than wire. Thus, compared with the case where the helical coil is entirely composed of wire, a variation in magnetic field distribution and a variation in inductance value can be suppressed. When the coil device 14 is used as the antenna, the following effects can be provided in the wireless communication device 10.

First, since the plurality of first conductors 16b are provided at a position relatively distant from the mount surface 18a it is possible to prevent pure resistance (DC resistance; Rdc) from being increased due to skin effect and, at the same time, suppress a variation in magnetic field distribution. As a result, a variation in communication distance of the coil device 14 serving as the antenna can be suppressed.

In use, when the coil device 14 is used as an antenna and receives or transmits a high-frequency signal, skin effect is generated in the helical coil 16 of the coil device 14. The skin effect is a phenomenon where alternating current tends to avoid passing through the center of a solid conductor, limiting itself to conduction near the surface. This effectively limits the cross-sectional area of the conductor which is available to carry alternating current flow, increasing the resistance of the conductor above what it would normally be for direct current. As a result of skin effect, current flows in a portion extending from the outer surface of the conductor inwardly to a predetermined depth (skin depth).

The skin depth varies as a function of the conductor material and the current frequency. As the frequency becomes high, the skin depth becomes small and the effective resistance of the conductor becomes high. The skin depth also varies as a function of the material used for the conductor. The skin depth is larger, and the effective resistance is lower, when copper is used rather than silver. The skin depth is larger, and the effective resistance is lower, when gold is used rather than copper.

As the aspect ratio (horizontal to vertical ratio) of the cross-sectional shape of the conductor approaches 1, and as the cross-sectional shape becomes less angular, the current can flow throughout the cross-section of the conductor. For example, in a case where the cross-sectional surface of the conductor is rectangular, the current intensively flows near the surface on a short side. Furthermore, in a case where the cross-sectional surface is angular (it is triangle, for example), the current intensively flows in an angular portion. Therefore, in order to make the current flow throughout the cross-section of the conductor, that is, in order to prevent the effective resistance of the conductor from being increased due to the skin effect, the cross-sectional surface of the conductor is preferably circular.

In order to minimize the skin effect, it is preferably that the plurality of conductor portions located remotely from the mount surface 18a, that is, the plurality of first conductors 16b largely contributing to the communication, are composed of the plurality of metal pins having the circular cross-sectional surface.

As shown in FIG. 4, the magnetic field generated by the coil device 14 extends upwardly and away from the main surface 12a of the circuit substrate 12. The first conductors 16b which are relatively far from the mount surface 18a (that is, circuit substrate 12) contributes more to the magnetic field distribution than the other conductors making up the helical coil 16. By using metal pins having a circular cross section for the first conductors 16b (which are the primary contributor to the magnetic field), the effective resistance can be prevented from being increased due to the skin effect and the signal decay and the power loss can be reduced in the first conductor 16b.

Furthermore, when the first conductor 16b is composed of the rigid metal pin instead of flexible metal material such as wire it is unlikely to change in shape compared with the case where it is composed of the wire. Therefore, the variation of the spacing between the first conductors 16b is small and the magnetic field distribution and a self-resonant frequency of the helical coil 16 are unlikely to vary. As a result, when the helical coil 16 is used as an antenna, its communication distance and frequency characteristic will have small variations.

Furthermore, because the first conductors 16b are internally contained in the element body 18, they do not change shape and the space between them can be stably maintained. Therefore, variations in the magnetic field distribution of the helical coil 16 can be reduced. If the coil made of wire is to be sealed with resin, due to resin flow at the time of sealing, the distance between segments of the wire is likely to vary and disconnection could occur in some cases.

In addition, similar to the first conductor 16b, the second conductor 16a is composed of a metal pin having a circular cross-sectional. Therefore, its effective resistance will not be increased due to skin effect. As a result, signal decay and power loss can be also reduced in the first conductor 16a.

Still furthermore, because the element body 18 has the plate-like (flat) cuboidal shape, the first and second conductors 16b and 16a are the longest conductors among the first to fourth conductors 16a to 16d in the helical coil 16, the helical coil 16 can be mostly composed of the metal pins and the coil device can function as an antenna having small losses and in a high communication distance.

As shown in FIG. 3, a distance D2 from the metal pin 16b at one end of the coil axis to the metal pin 16b at the other end of the coil axis is smaller than a distance D1 from the metal pin 16a at one end of the coil axis to the metal pin 16a at the other side of the coil axis. Therefore, compared with a case where the distances D1 is equal to the distance D2, a coil opening of the helical coil 16 can be larger in area, and the coil opening can face a top surface side, so that the communication distance in a top surface direction can be increased.

### Embodiment 2

A wireless communication device in embodiment 2 differs from the wireless communication device in embodiment 1 by the second conductor in the helical coil of the coil device. The wireless communication device in the embodiment 2 will be described with a focus on this difference.

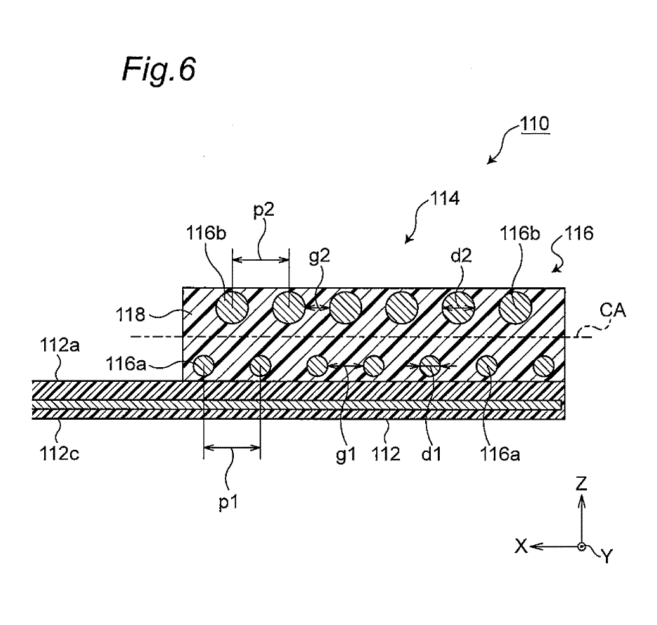

FIG. 6 is a partial cross-sectional view of the wireless communication device having a coil device used as an antenna. As shown in FIG. 6, a helical coil 116 of a coil device 114 has a plurality of second conductors 116a and a plurality of first conductors 116b internally contained in an element body 118.

The plurality of second conductors 116a are preferably located in a common plane and are spaced at regular intervals along the coil axis CA (X-axis direction), more specifically, at a predetermined pitch interval p1. The plurality of first conductors 116b are also preferably located in a common plane and are spaced at regular intervals along the coil axis CA at regular intervals, more specifically, at a predetermined pitch interval p2. In embodiment 2, the pitch interval pl is preferably equal to the pitch interval p2.

While pitch intervals p1 and p2 are equal in length, the distance (space) g1 between the adjacent first conductors 116a along the coil axis CA (X-axis direction) is preferably different than a distance (space) g2 between the adjacent second conductors 116b along the coil axis CA. More specifically, the space g2 of the first conductors 116b is preferably smaller than the space g1 of the second conductors 116a.

Because the space g2 of the first conductors 116b is smaller than the space g1 of the second conductors 116a, a length of a cross-sectional surface (that is, a diameter d2) of the first conductor 116b in the X-axis direction of the coil axis CA is larger than a length (diameter d1) of the second conductor 116a in the X-axis direction of the coil axis CA. Stated otherwise, the metal pins used for the first conductors 116b are thicker than the metal pin used for the second conductors 116a.

In this way, when the plurality of first conductors 116b which primarily contribute to the magnetic field distribution have larger cross-section and are more closely spaced, the magnetic field of the helical coil 116 can expand greatly. More particularly, when the space g2 is small, a magnetic flux generated from one of the adjacent first conductors 116b across the space g2 and passing through the space g2 is prevented from being canceled by a magnetic flux generated from the other and passing through the space g2. As a result, a minor loop can be prevented from being generated in a portion of the helical coil 116 which mainly contributes to magnetic field coupling, with a coil (antenna) on a communication partner side, so that a power supplied to the helical coil 116 can be effectively used for forming the magnetic field for the wireless communication. As a result, the coil device 114 having the helical coil 116 is high in energy efficiency.

Like embodiment 1, the plurality of first conductors 116b of embodiment 2 reduce skin effect and prevent the effective resistance from being increased while at the same time suppressing variations in magnetic field distribution. Furthermore, the coil device 114 can form the magnetic field for the wireless communication energetically high in efficiency.

### Embodiment 3

A wireless communication device in embodiment 3 differs from the wireless communication device in embodiment 1 by the second conductor in the coil device. The wireless communication device in embodiment 3 will be described with a focus on this difference.

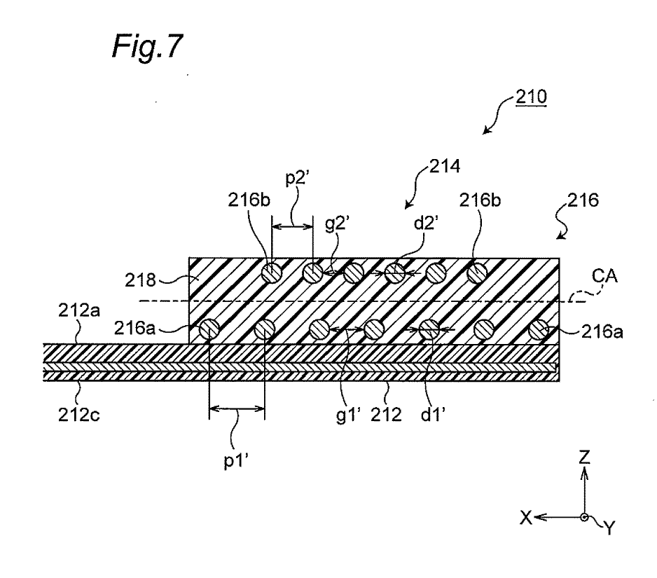

As shown in FIG. 7, a helical coil 216 of a coil device 214 has a plurality of second conductors 216a and a plurality of first conductors 216b internally contained in an element body 218, similar to the helical coil 16 in embodiment 1.

The plurality of second conductors 216a arranged at regularly spaced locations along the coil axis CA (X-axis direction), more specifically, at a predetermined pitch interval p1′. The plurality of first conductors 216b are similarly arranged at regular spaced locations along the coil axis CA, more specifically, at a predetermined pitch interval p2′.

In embodiment 3, the diameter d1′ of the first conductor 216a is equal to the diameter d2′ of the first conductor 216b. However, a distance (space) g1′ between the adjacent first conductors 216a along the coil axis CA (X-axis direction) differs from a distance (space) g2′ between adjacent first conductors 216b along the coil axis CA. More specifically, the space g2′ is smaller than the space g1

Because the space g2′ is smaller than the space g1′, the pitch interval p2′ of the plurality of first conductors 116b is smaller than the pitch interval p1′ of the plurality of second conductors 216a. Thus, when the plurality of first conductors 216b (which largely contribute to the magnetic field distribution toward an upper part of the main surface 212a of the circuit substrate 212) have the small space g2′, the magnetic field of the helical coil 216 can be significantly enlarged. This is because when the space g2′ is small, the magnetic flux generated from one of two adjacent first conductors 216b (and passing through the space g2′) is prevented from being canceled by the magnetic flux generated from the other of the two adjacent first conductors 216b and (also passing through the space g2′). Thus, power supplied to the helical coil 216 can be effectively used for forming the magnetic field for the wireless communication. As a result, the coil device 214 having the helical coil 216 is high in energy efficiency.

According to embodiment 3, the effective resistance of the plurality of first conductors 216b, which are the primary contributors to the communication (and are distant from the mount surface) can be prevented from being increased due to the skin effect and at the same time, a variation in magnetic field distribution can be suppressed. Furthermore, the coil device 214 can form the magnetic field for the wireless communication energetically high in efficiency.

### Embodiment 4

The wireless communication device in embodiment 4 differs from the wireless communication device in embodiment 1 by presence of a magnetic body 330. The wireless communication device in the embodiment 4 will be described with a focus on this difference.

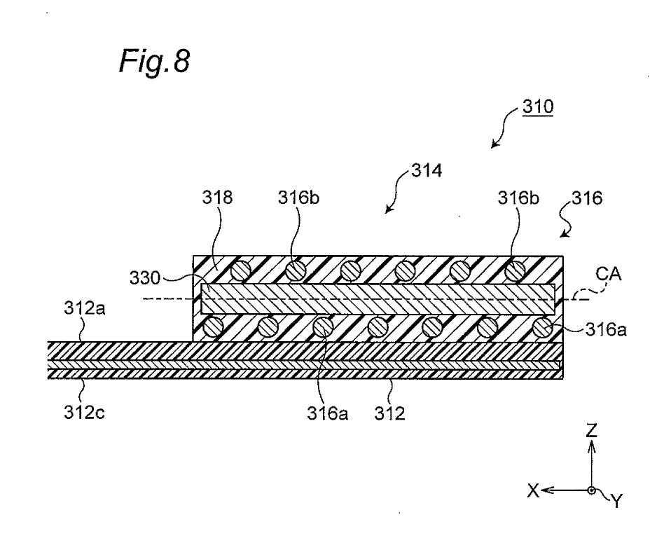

As shown in FIG. 8, the coil device 314 has a magnetic body 330 unlike the coil device 14 in embodiment 1. The magnetic body 330 is preferably a magnetic body made of ferrite ceramics, or a magnetic body in which ferrite powder is dispersed in a resin and has a plate-like shape. The magnetic body 330 is internally contained in an element body 318 within a helical coil 316. That is, the magnetic body 330 is disposed between a plurality of second conductors 316a and a plurality of first conductors 316b of the helical coil 316 and held by the plurality of second conductors 316a and the plurality of first conductors 316b.

When the magnetic body 330 is disposed in the helical coil 316, a magnetic field generated by the helical coil 316 can largely expand. As a result, a communicatable distance of a wireless communication device 310 having the coil device 314 as an antenna can be increased.

According to embodiment 4, the skin effect in the plurality of first conductors 316b (which are the primary contributors to the communication) can be lowered and the effective resistance of the helical coil 316 can be prevented from being increased. At the same time, a variation in magnetic field distribution can be suppressed. Furthermore, the wireless communication device 310 can be long in communicatable distance.

Furthermore, since the plate-like magnetic body 330 is held by the plurality of second conductors 316a and the plurality of first conductors 316b, the magnetic body 330 is not likely to be moved due to resin flow generated when an element body 318 is formed, so that the coil device can have small manufacturing variations.

### Embodiment 5

A wireless communication device in embodiment 5 differs from the wireless communication device in embodiment 1 by the connection between the coil device and the terminal on the circuit substrate. The wireless communication device in embodiment 5 will be described with a focus on this difference.

In embodiment 1 (shown in FIG. 1) the coil device 14 has respective connection terminals 20 for electrically connecting the helical coil 16 to respective terminals 12d on the circuit substrate 12, on each of the end surfaces 18b and 18c which do not face the main surface 12a of the circuit substrate 12. The connection terminal 20 is electrically connected to the terminal 12d of the circuit substrate 12 through the conductive bonding material 22 such as solder.

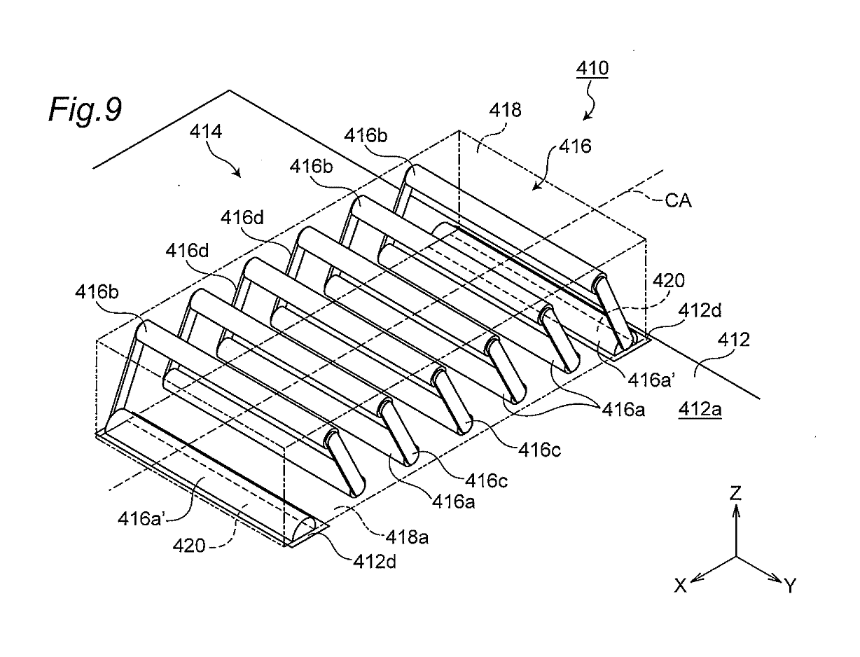

In contrast, as shown in FIG. 9, a coil device 414 in embodiment 5 has a connection terminal 420 which is located on a mount surface 418a facing a main surface 412a of a circuit substrate 412. More specifically, each of the two connection terminals 420 is preferably composed of a second conductor 416a′ provided at each opposite ends of the plurality of second conductors 416a relative to the coil axis CA (X-axis direction).

Each of the second conductors 416a′, located at opposite ends of the coil axis CA (X-axis direction), are composed of a metal pin which is thicker than the other second conductors 416a and has a roughly semicircular cross-section with, for example, a planar surface facing the main surface 412a of the circuit substrate 412. Each planar surface is exposed on an outside of the element body 418, more particularly on the mount surface 418a of the element body 418, and functions as a respective connection terminal 420 of the coil device 414. A plated film is preferably formed on a surface of the connection terminal 420.

A terminal 412d is provided on the main surface 412a of the circuit substrate 412 facing the connection terminal 420 (the planar surface of the second conductor 416a′) of the coil device 414. Therefore, when the coil device 414 is mounted on the main surface 412a of the circuit substrate 412, the connection terminal 420 of the coil device 414 comes in contact with the terminal 412d of the circuit substrate 412. As a result, an LGA type terminal electrode can be formed and the helical coil 416 of the coil device 414 can be connected to the terminal 412d of the circuit substrate 412 through conductive bonding material such as solder.

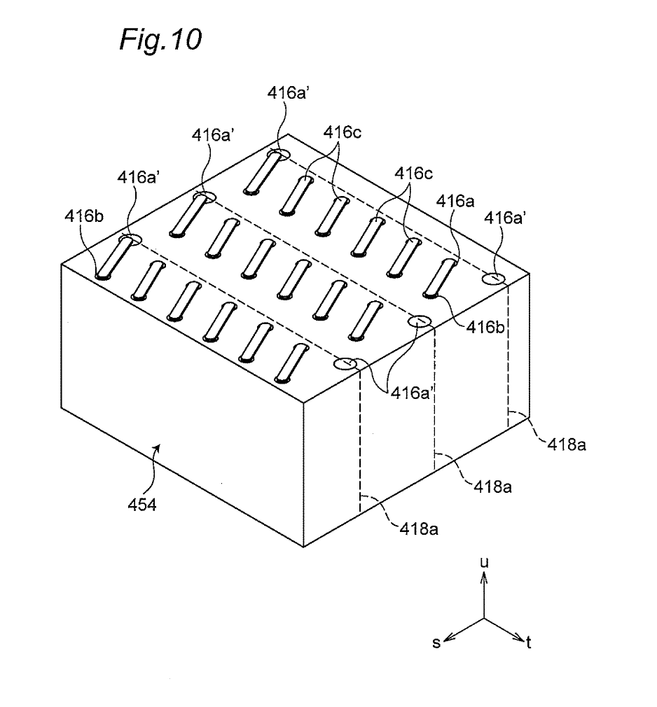

The connection terminal 420 composed of the planar surface of the second conductor 416a′ is preferably manufactured such that, as shown in FIG. 10, a resin block 454 internally containing the second conductors 416a (416a′) and the first conductor 416b is cut across the first conductor 416a′, for example. That is, the cut surface of the resin block 454 becomes the mount surface 418a of the element body 418, and the cut surface of the metal pin becomes the terminal surface.

According to embodiment 5, the plurality of first conductors 416b are the primary contributors to the communication. Since they are circular in cross-section an increase in the effective resistance due to the skin effect can be mitigated and, at the same time, a variation in magnetic field distribution can be suppressed. Furthermore, the helical coil 416 of the coil device 414 can be easily connected to the terminal 412d on the circuit substrate 412.

In this embodiment, the metal pins constituting the second conductors 416a′ have a diameter which is larger than the diameter of the metal pins constituting the other first conductors 416a, but the diameter may be equal to each other.

### Embodiment 6

A wireless communication device in embodiment 6 differs from the wireless communication device in embodiment 1 by the first conductor of the coil device. The wireless communication device in embodiment 6 will be described with a focus on this difference.

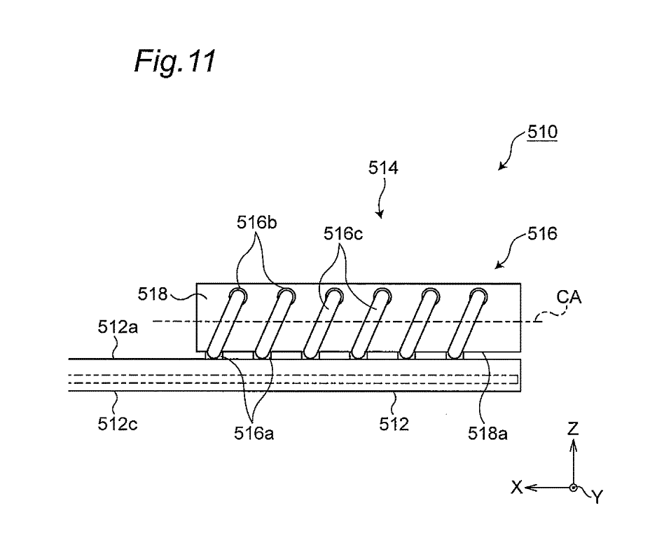

As shown in FIG. 11, the coil device 514 has a plurality of second conductors 516a (forming part of a helical coil 516) which are composed of a metal member having a rectangular cross-section. Each of the second conductors 516a is provided on the mount surface 518a (an outer surface) of the element body 518 facing a main surface 512a of the circuit substrate 512 instead of being provided inside the element body 518. The second conductor 516a is preferably a conductive pattern formed on the mount surface 518a of the element body 518, for example.

Each of the first conductors 516b have a circular cross-section and are regularly spaced along the axial direction of coil axis CA (X-axis direction) of the helical coil 516 at a position remote from the circuit substrate 512. The first conductors 516b are the primary contributor to an magnetic field distribution extending upwardly from the main surface 512a of the circuit substrate 512. Therefore, even though the plurality of second conductors 516a have a rectangular cross-section and the effective resistance of the second conductors 516a is high compared with a circular cross-section, and even through they are provided outside the element body 518, a significant negative effect is avoided.

An advantage of embodiment 6 is that because the plurality of second conductors 516a are provided outside element body 518 and have a rectangular cross-section, a method for manufacturing the coil device has a high degree of freedom. For example, the plurality of second conductors 516a of the helical coil 516 may be formed on the main surface 512a of the circuit substrate 512 instead of being formed on the element body 518 of the coil device 514.

In this case, the circuit substrate 512 has the plurality of second conductors 516a arranged in parallel (in the X-axis direction) on the main surface 512a. On the other hand, the element body 518 has the plurality of first conductors 516b, a plurality of third conductors 516c, and a plurality of fourth conductors. That is, the first conductor 516b, the third conductor 516c, and the fourth conductor constitute a semi-ring-shaped conductor having an opening on a side of the mount surface 518a, and a plurality of semi-ring-shaped conductors are arranged in parallel along the parallel direction of the first conductors 516a (X-axis direction).

The element body 518 is mounted on the circuit substrate 512 such that the plurality of third conductors 516c and the plurality of fourth conductors on the element body 518 are connected to the plurality of first conductors 516a on the circuit substrate 512. Thus, a coil device 514 having the helical coil 516 is constituted. That is, the element body 518 having the plurality of semi-ring-shaped conductors serves as a surface mount type component which is mounted on the circuit substrate 512 as part of the coil device 514. Thus, a wireless communication device 510 is composed of the element body 518 and the circuit substrate 512. In addition, the plurality of second conductors 516a on the circuit substrate 512 are connected to the plurality of third conductors 516c and the plurality of fourth conductors on the element body 518 through conductive bonding material such as solder.

According to embodiment 6, it is possible to minimize the skin effect in the plurality of first conductors 516b due to their circular cross-section. Because the first conductors 516b are located remotely from the circuit subtract 512 and are the primary contributors to the magnetic field, a variation in magnetic field distribution can be suppressed. Furthermore, a method for manufacturing the coil device has a high degree of freedom.

In addition, the plurality of second conductors 516a may be formed on the side of the mount surface of the element body 518. In this case, conductive paste may be patterned by screen printing, or a metal film may be entirely patterned by etching.

### Embodiment 7

The coil device used in the wireless communication device of embodiment 7 is the same as the coil device of embodiment 1. Therefore, a detailed description for a constitution of the coil device is omitted.

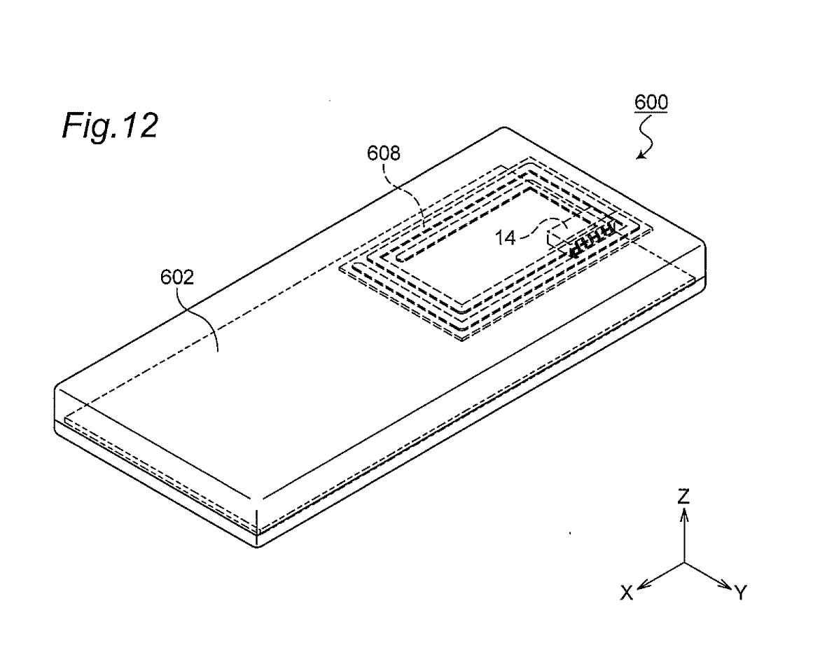

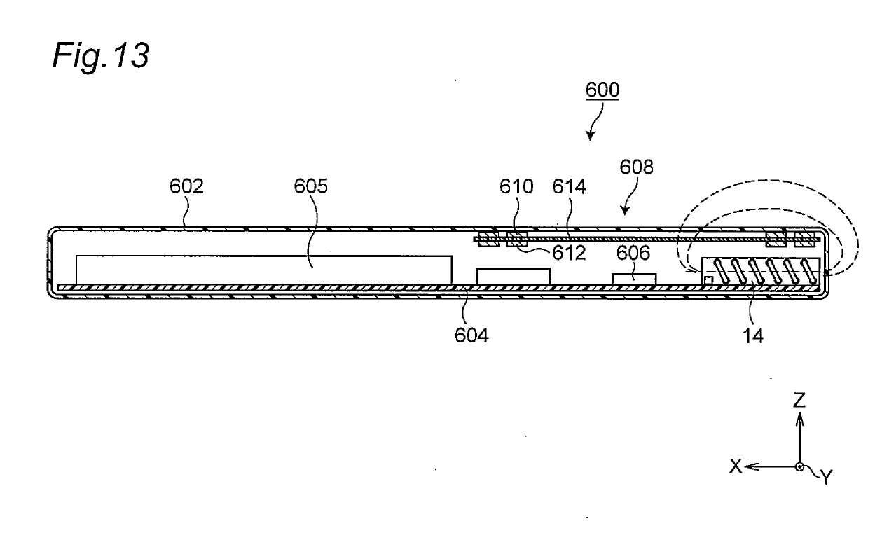

FIG. 12 shows a wireless communication device 600 serving as a mobile terminal having the coil device 14 in the embodiment 1 used as an antenna, for example. FIG. 13 is a cross-sectional view of the wireless communication device 600.

As shown in FIG. 12, the wireless communication device 600 has a casing 602 which accommodates the coil device 14 and a circuit substrate 604. As best shown in FIG. 13, battery 605 for driving the wireless communication device 600 and a component 606 for receiving and transmitting a signal having a frequency in the HF band through the coil device 14 are mounted on the circuit substrate 604 together with the coil device 14. Furthermore, the casing 602 also accommodates a booster antenna (coil antenna) 608 having a resonant frequency in the HF band.

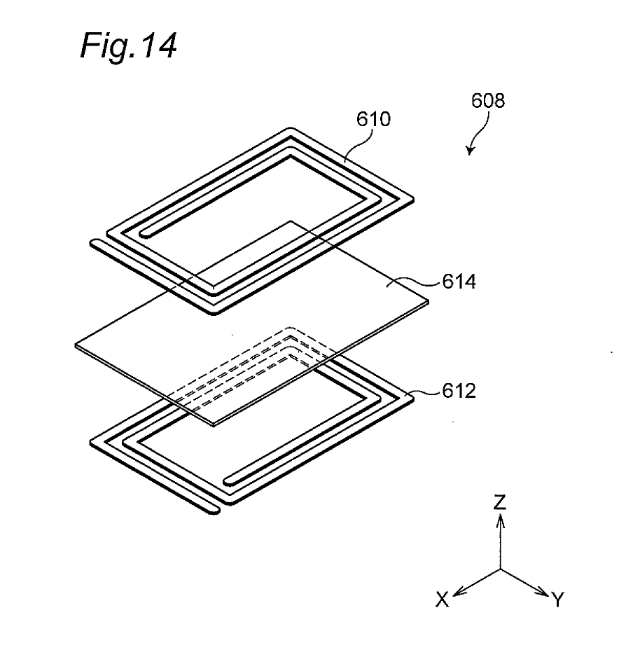

As shown in FIG. 14, the booster antenna 608 has a first coil pattern 610, a second coil pattern 612, and an insulating plate 614 which is interposed between them to support them. Each of the first coil pattern 610 and the second coil pattern 612 has a rectangular spiral shape and are formed on the insulating plate 614, for example. Furthermore, openings of the first and second coil patterns 610 and 612 are larger in area than the opening of the helical coil in the coil device 14.

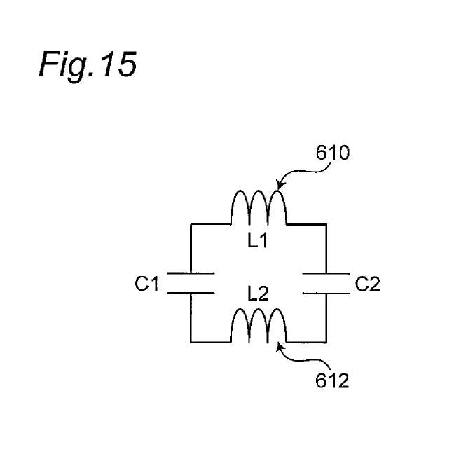

The first and second coil patterns 610 and 612 are configured to be capacitively coupled with each other when a current flows in the same direction, or when a current flows clockwise at viewing in a direction (Z-axis direction) perpendicular to the insulating plate 614, for example. Therefore, floating capacitance is formed between the first coil pattern 610 and the second coil pattern 612. Thus, as shown in FIG. 15, a resonant circuit is composed of an inductance L1 of the first coil pattern 610, an inductance L2 of the second coil pattern 612, and floating capacitances C1 and C2 between terminals of the first and second coil patterns 610 and 612. The booster antenna 608 is configured such that a resonance frequency of the resonant circuit matches with the frequency in the HF band of the signal received by and transmitted from the coil device 14 such as 13.56 MHz.

The booster antenna 608 is accommodated in the casing 602 in such a manner that it does not overlap the battery 605, and the first and second coil patterns 610 and 612 are partially located in the magnetic field (broken line) generated from the coil device 14. Thus, magnetic coupling is generated between the coil device 14 (the helical coil in it) and the booster antenna 608, and a current flows in a circuit of the booster antenna 608. Since the openings of the first and second coil patterns 610 and 612 of the booster antenna 608 are larger in area than the opening of the helical coil in the coil device 14, a large magnetic field is formed compared with a case where the coil device 14 is only provided. As a result, a communicatable distance of the wireless communication device 600 can be increased.

### Embodiment 8

Embodiment 8 is an improved embodiment of embodiment 5. Therefore, embodiment 8 will be described with a focus on the point of difference from embodiment 5.

As shown in FIGS. 9 and 10, the coil device 414 of embodiment 5 includes a pair of second conductors 416a′ composed of the metal pin having a circular cross-section which has been cut along the planar surface including a center axis of the metal pin, and its rectangular cut surface is used as the connection terminal 420. However, since the second conductor 416′ is the metal pin having the circular cross-sectional surface, its cut surface (the terminal surface of the connection terminal 420) can vary in size. That is, when the metal pin is not cut along the center axis of the metal pin, the cut surface varies in size depending on a distance from the center axis. When the cut surface (the terminal surface of the connection terminal 420) varies in size, the impedance of the connection terminal 420 varies, and as a result, communication characteristics of the wireless communication device also varies.

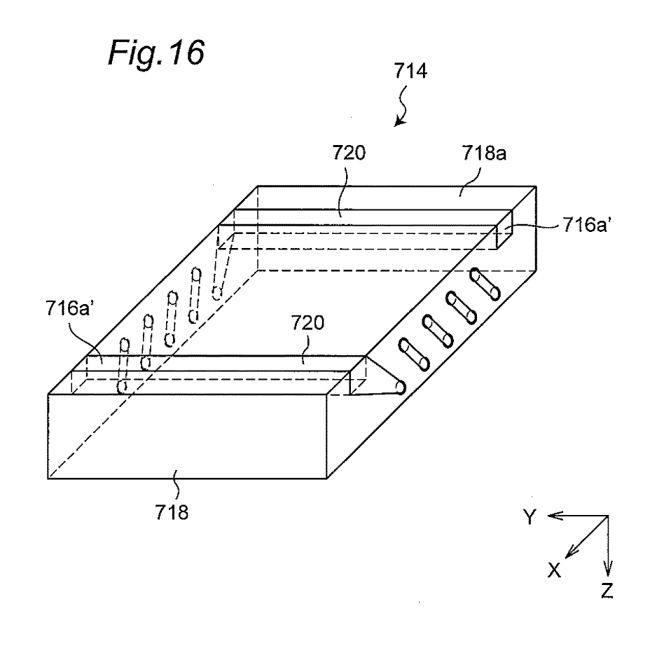

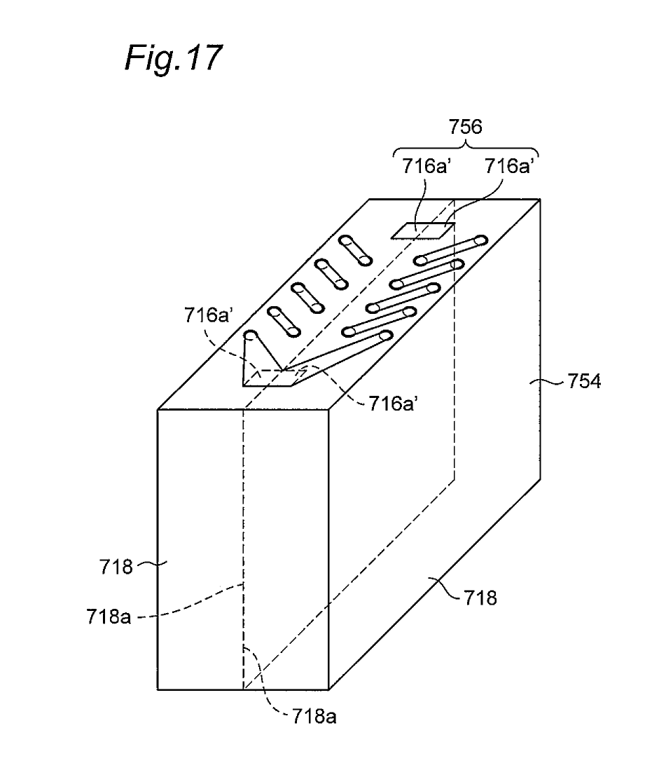

To avoid this problem, in the coil device 714 in embodiment 8, as shown in FIGS. 16 and 17, a cuboid-shaped (rectangular cross-section) metal block 756 is provided in a resin block 754 and is cut in half to make two second conductors 716a′. Thus, a cut surface, that is, a connection terminal 720 is formed. Thus, when the cuboid-shaped metal block 756 is cut, the cut surface is constant in size even when the location of the cut varies. Therefore, the terminal surface of the connection terminal 720 does not vary in size and has a constant size. As a result, a variation in communication characteristics of a wireless communication device can be suppressed.

### Embodiment 9

In the above embodiments, in embodiment 1 for example, and as shown in FIG. 1, the coil device 14 is mounted on the circuit substrate 12 which is larger than the coil device 14. Thus, the wireless communication device 10 is relatively large in size.

In embodiment 9, a coil device is mounted on a circuit substrate having the same or smaller size. In other words, the circuit substrate is mounted on the coil device, and a wireless communication device is relatively small in size.

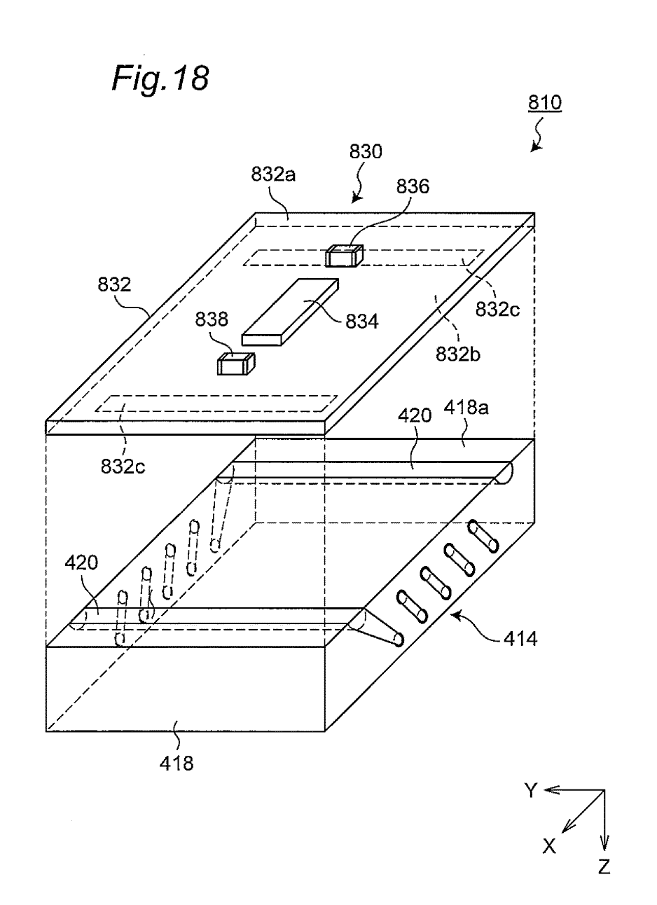

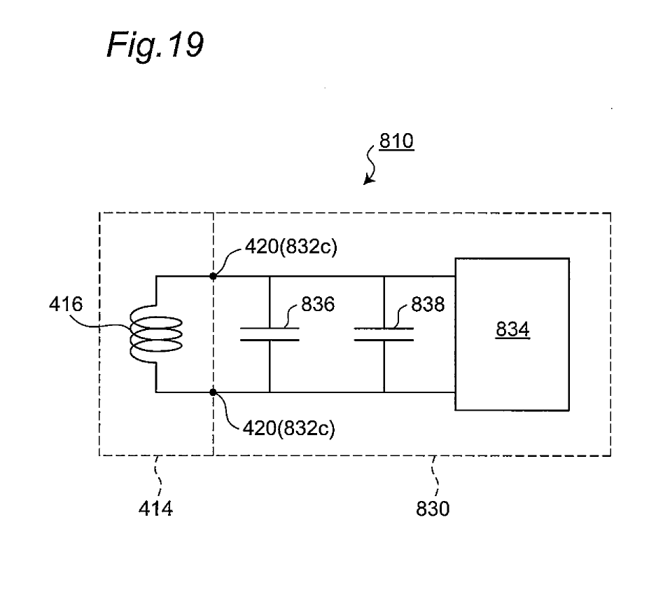

FIG. 18 shows a wireless communication device 810 in accordance with embodiment 9. The wireless communication device 810 is a RFID (Radio Frequency Identification) tag. As shown in FIG. 18, the wireless communication device 810 has the coil device 414 of embodiment 5 and a circuit substrate 830 mounted on it. The circuit substrate 830 has a flexible substrate 832 made of thermoplastic resin, an RFIC (Radio Frequency Integrated Circuit) element 834 mounted on a main surface 832a of the substrate 832, and two capacitor elements 836 and 838 also mounted on the main surface 832a of the substrate 832. As shown in FIG. 19, a RFID circuit is composed of the RFIC element 834, the capacitor element 836, the capacitor element 838, and the helical coil 416 of the helical coil 414.

Furthermore, as shown in FIG. 18, a back surface 832b of the substrate 832 is bonded to the mount surface 418a of the coil device 414 (the back surface of the element body 418). At this time, the connection terminal 420 on the mount surface 418a of the coil device 414 is electrically connected to a connection terminal 832c on the back surface 832b of the substrate 832. As shown in FIG. 19, the connection terminal 832c is connected to the RFIC element 834. Furthermore, instead of the capacitor elements 836 and 838, a capacitor pattern may be provided on the substrate 832.

### Embodiment 10

A wireless communication device in embodiment 10 is a RFID tag similar to embodiment 9. Therefore, it will be described with a focus on a point different from embodiment 9.

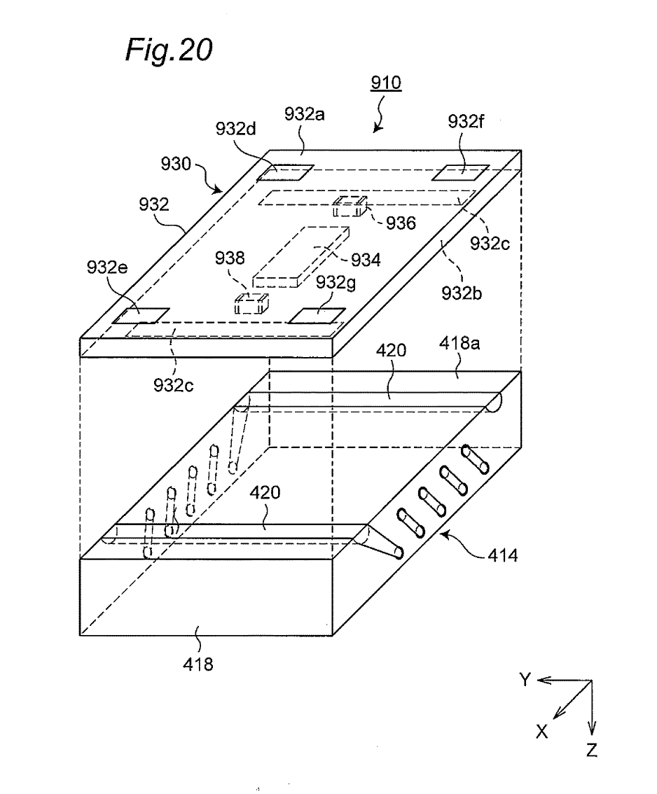

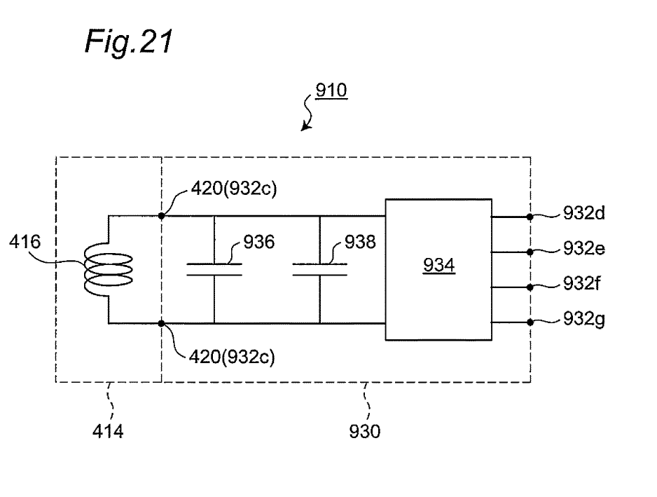

As shown in FIG. 20, a wireless communication device 910 of embodiment 10 has the coil device 414 of embodiment 5 and a circuit substrate 930 mounted on it. The circuit substrate 930 has a flexible substrate 932 made of thermoplastic resin, an RFIC (Radio Frequency Integrated Circuit) element 934 incorporated in the substrate 932 and two capacitor elements 936 and 938 also incorporated in the substrate 932. As shown in FIG. 21, an RFID circuit is composed of the RFIC element 934, the capacitor element 936, the capacitor element 938, and the helical coil 416 of the coil device 414.

Furthermore, the circuit substrate 930 has a plurality of connection terminals 932d to 932g to electrically connect the RFIC element 934 with an external control circuit or power supply circuit. The plurality of connection terminals 932d to 932g are provided on the main surface 932a of the substrate 932.

A back surface 932b of the substrate 932 is bonded to the mount surface 418a of the coil device 414 (the back surface of the element body 418). At this time, the connection terminal 420 on the mount surface 418a of the coil device 414 is electrically connected to a connection terminal 932c on the back surface 932b of the substrate 932. As shown in FIG. 21, the connection terminal 932c is connected to the RFIC element 934.

Furthermore, instead of the capacitor elements 936 and 938, a capacitor pattern may be provided on the substrate 932.

### Embodiment 11

In the above embodiments, the coil device is used as the antenna in the wireless communication device. In the embodiment 11, the electronic device has a coil device which is used for a purpose other than the antenna.

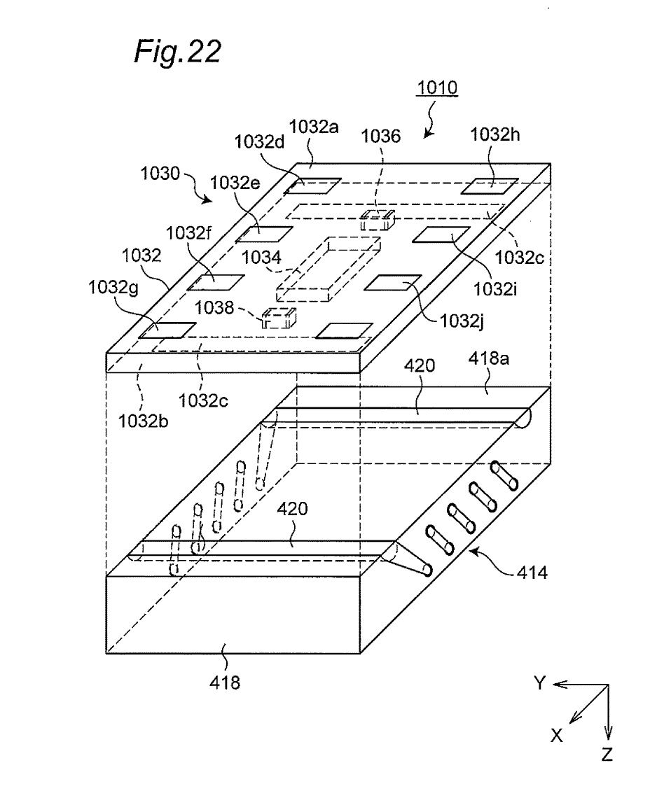

FIG. 22 shows a DC-DC converter module serving as one example of the electronic device in the embodiment 11 of the present invention. As shown in FIG. 22, a DC-DC converter module 1010 has the coil device 414 in the embodiment 5 and a circuit substrate 1030 mounted on it.

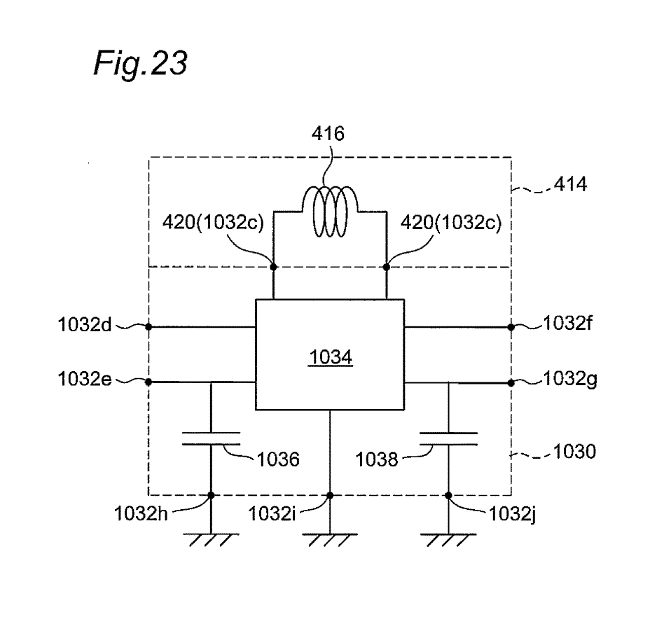

As shown in FIG. 22, the circuit substrate 1030 has a flexible substrate 1032 made of thermoplastic resin, a switching IC element 1034 incorporated in the substrate 1032, and two capacitor elements 1036 and 1038 also incorporated in the substrate 1032. As shown in FIG. 23, a DC-DC converter circuit is composed of the switching IC element 1034, the capacitor element 1036, the capacitor element 1038, and the helical coil 416 of the coil device 414. The helical coil 416 functions as a choke coil.

In addition, the circuit substrate 1030 has a plurality of connection terminals 1032d to 1032j to ground the switching IC element 1034, or electrically connect it with an external control circuit or power supply circuit. The plurality of connection terminals 1032d to 1032j are provided on the main surface 1032a of the substrate 1032.

Furthermore, as shown in FIG. 22, a back surface 1032b of the substrate 1032 is bonded to the mount surface 418a of the coil device 414 (the back surface of the element body 418). At this time, the connection terminal 420 on the mount surface 418a of the coil device 414 is electrically connected to a connection terminal 1032c on the back surface 1032b of the substrate 1032. As shown in FIG. 23, the connection terminal 1032c is connected to the switching IC element 1034.

Furthermore, instead of the capacitor elements 1036 and 1038, a capacitor pattern may be provided on the substrate 1032.

### Embodiment 12

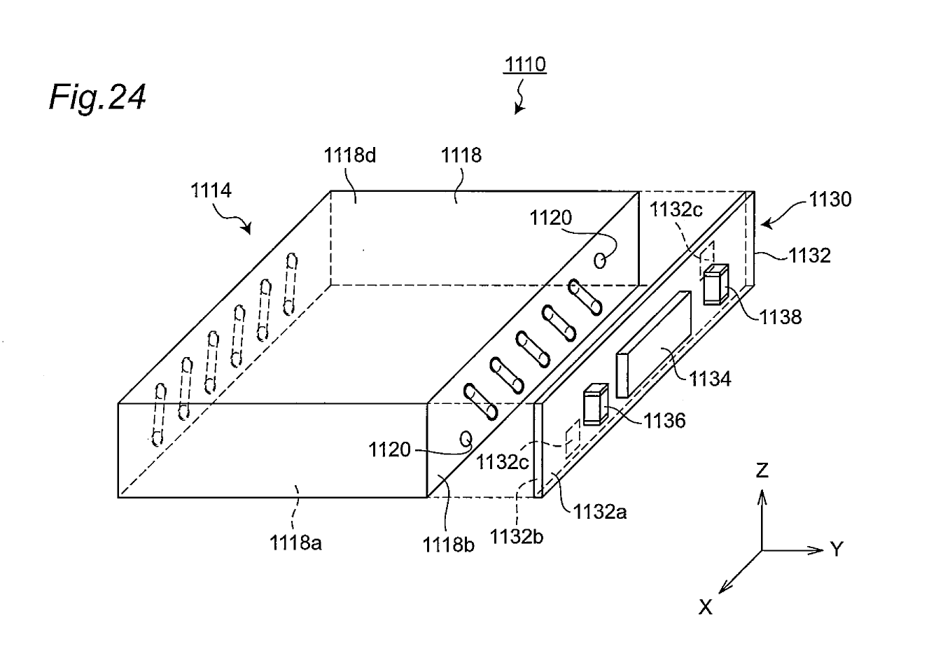

In the above plurality of embodiments, the back surface of the coil device is mounted on the circuit substrate. That is, the coil device is mounted on the circuit substrate through the relatively large surface (compared with the end surface) of the plate-like element body. In contrast, in embodiment 12, a coil device is mounted on (bonded to) a circuit substrate through its end surface. That is, the end surface of the plate-like element body is used as a mount surface of the coil device. More specifically, a wireless communication device 1110 in the embodiment 12 of the present invention shown in FIG. 24 is an RFID tag having the same RFID circuit (refer to FIG. 19) as in embodiment 9.

As shown in FIG. 24, the wireless communication device 1110 in the embodiment 12 of the present invention has a coil device 1114 having a helical coil and a circuit substrate 1130 mounted on it. The coil device 1114 has a connection terminal 1120 connected to the helical coil at each end, on its end surface 1118b, instead of a back surface 1118a or a main surface 1118d of a plate-like element body 1118. The circuit substrate 1130 has a flexible substrate 1132 made of thermoplastic resin, an RFIC element 1134 mounted on a main surface 1132a of the substrate 1132, and two capacitor elements 1136 and 1138 also mounted on the main surface 1132a of the substrate 1132.

A back surface 1132b of the substrate 1132 is bonded to the mount surface 1118b of the coil device 1114 (end surface 1118b of the element body 1118). At this time, the connection terminal 1120 on the mount surface 1118b of the coil device 1114 is electrically connected to a connection terminal 1132c on the back surface 1132b of the substrate 1132. The connection terminal 1132c is connected to the RFIC element 1134.

### Embodiment 13

A wireless communication device in embodiment 13 is a RFID tag including the same RFID circuit (refer to FIG. 21) as in embodiment 10. However, a coil device is bonded to a circuit substrate through its end surface, similar to embodiment 12.

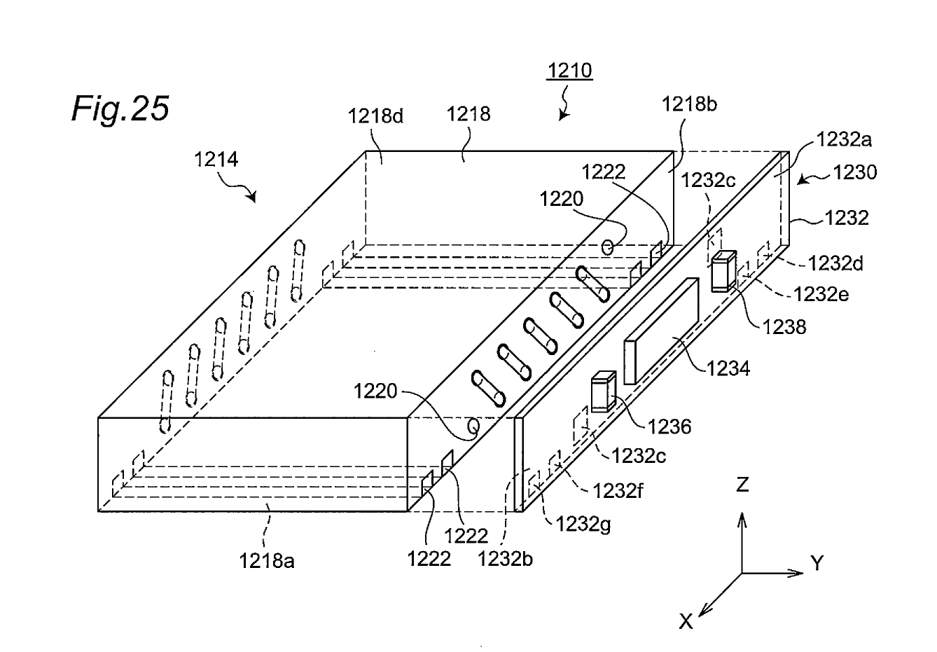

As shown in FIG. 25, a wireless communication device 1210 in the embodiment 13 has a coil device 1214 and a circuit substrate 1230 mounted on it. The coil device 1214 has a connection terminal 1220 connected to the helical coil at each end, on its mount surface 1218b (an end surface of an element body 1218). The circuit substrate 1230 has a flexible substrate 1232 made of thermoplastic resin, an RFIC element 1234 mounted on a main surface 1232a of the substrate 1232, and two capacitor elements 1236 and 1238 also mounted on the main surface 1232a of the substrate 1232.

A back surface 1232b of the substrate 1232 is bonded to the mount surface 1218b of the coil device 1214 (the end surface of the element body 1218). At this time, the connection terminal 1220 on the mount surface 1218b of the coil device 1214 is electrically connected to a connection terminal 1232c on the back surface 1232b of the substrate 1232. The connection terminal 1232c is connected to the RFIC element 1234.

In embodiment 13, a plurality of connection terminals 1232d to 1232g which electrically connect the RFIC element 1234 with an external control circuit or power supply circuit are provided on the back surface 1232b of the substrate 1232. A plurality of conductors 1222 connected to the respective connection terminals 1232d to 1232g are provided in the coil device 1214.

Each of the plurality of conductors 1222 is a conductor layer formed from the back surface 1218a and extending along the end surface 1218b of the element body 1218. In addition, each of the plurality of conductors 1222 is a metal pin internally contained in the element body 1218 and exposed on an outside of the back surface 1218a and the end surface 1218b of the element body 1218, for example.

Embodiment 13 is useful when the end surface 1218b of the coil device 1214 is very small, that is, when the main surface 1232a of the substrate 1232 having the mounted RFIC element 1234 has no space for the connection terminal to be externally connected.

The present invention has been described with the above-described plurality of embodiments, but the present invention is not limited to the embodiments.

For example, in the above plurality of embodiments, the helical coil of the coil device is composed of the first to fourth conductors. However, an embodiment of the present invention is not limited to this. More broadly, the coil device in the embodiment of the present invention has the plate-like element body having the main surface, the back surface, and the end surface, the helical coil provided in the element body and having the coil axis extending between the main surface and the back surface, and the connection terminal provided on the back surface or the end surface of the element body and connected to the helical coil, in which as for the conductor constituting the helical coil, the plurality of conductor portions extending along the main surface are composed of the plurality of metal pins, respectively.

Furthermore, in the above plurality of embodiments, as for the wireless communication device serving as one example of the electronic device, the coil device serving as the antenna is mounted at the end of the main surface of the circuit substrate. Instead of this, it may be mounted at another place such as center of the main surface of the circuit substrate.

Furthermore, the first to fourth conductors of the helical coil may be made of the same material or different material. For example, in order to prevent the increase in pure resistance of the second conductor which largely contributes to the magnetic field distribution, the metal pin of the second conductor may be made of material in which a skin depth is large. For example, when the metal pin of the second conductor is made of gold and the other conductor is made of copper, the pure resistance of the second conductor can be prevented from being increased and at the same time, the helical coil can be manufactured at low cost (compared with a case where all of the conductors of the helical coil are made of gold).

Still furthermore, as shown in FIG. 2, for example, when the first conductor and the second conductor are composed of the metal pin common to each other, the respective first and second conductors are preferably parallel to each other. The reason for this is that as shown in FIG. 5A, the plurality of metal pins can be easily set when the coil device is manufactured.

As for the first and second conductors, in the above plurality of embodiments, as shown in FIG. 3, for example, the first conductors arranged in the extending direction of the coil axis (X-axis direction) at the position close to the mount surface (circuit substrate) are not disposed face-to-face with the second conductors arranged in the extending direction of the coil axis at the position distant from the mount surface (circuit substrate), in the direction (Z-axis direction) perpendicular to the circuit substrate. Instead of this, the helical coil may be configured such that the first conductor is disposed face-to-face with the second conductor in the direction perpendicular to the circuit substrate.

Furthermore, the coil device serving as the antenna in the above embodiments of the present invention is not limited to be used to transmit and receive the signal having a frequency in the HF band, it can be used to transmit and receive a signal having a frequency in various bands. The coil device serving as the antenna in the above embodiments of the present invention may be used to transmit and receive a signal having a frequency in a UHF band, for example.

Finally, a new embodiment can be provided by combining at least one of the characteristics in any of the above embodiments, in the other embodiment. For example, when the magnetic body 330 of the coil device 314 in the embodiment 4 is disposed in the coil device 14 in the embodiment 1, a new embodiment can be provided. In addition, when the coil device 114 in the embodiment 2 is applied to the wireless communication device 600 in the embodiment 7, a new embodiment can be provided.

The coil device in the present invention is applicable not only to the wireless communication device and the DC-DC converter module, but also to other devices using a coil.

1. A coil device comprising:
a plate-like element body having a main surface, a back surface, and an end surface;
a helical coil having a coil axis extending between the main surface and the back surface of the element body, the helical coil including a first plurality of conductive portions located closer to the main surface of the element body than to the back surface of the element body, each of the first plurality of conductive portions being a conductive pin; and
a connection terminal provided on at least one of the back surface and the end surface of the element body and connected to the helical coil.

2. The coil device according to claim 1, wherein the helical coil further comprise a second plurality of conductive portions located closer to the back surface of the element body than to the main surface of the element body, each of the plurality of the conductive portions being a conductive pin.

3. The coil device according to claim 2, wherein the first plurality of conductive portions are spaced apart from each other by a first distance as measured along the coil axis and the second plurality of conductive portions are spaced apart from each other by a second distance as measured along the coil axis, the first and second distances being different than each other.

4. The coil device according to claim 3, wherein the first distance is smaller than the second distance.

5. The coil device according to claim 2, wherein each of the conductive portions of the first and second plurality of conductive portions are circular in cross-section.

6. The coil device according to claim 5, wherein the conductive portions of the first plurality of conductive portions have a larger diameter than the conductive portions of the second plurality of conductive portions.

7. The coil device according to claim 2, wherein:
the first plurality of conductive portions include first and second outer conductive portions, the remaining conductive portions of the first plurality of conductive portions being located between the first and second outer conductive portions;
the second plurality of conductive portions include third and fourth outer conductive portions, the remaining conductive portions of the second plurality of conductive portions being located between the third and fourth outer conductive portions; and
the distance between the first and second outer conductive portions, as measured along the coil axis, being less than the distance between the third and fourth outer conductive portions as measured along the coil axis.

8. The coil device according to claim 2, wherein the second plurality of conductive portions including first and second outer conductive portions, the remaining conductive portions of the second plurality of conductive portions being located between the first and second outer conductive portions, at least a portion of the first and second outer conductive portions being exposed at the back surface side of the element body and acting as a connection terminal portion.

9. The coil device according to claim 8, wherein the first and second outer conductive portions are made of cuboidal metal blocks, and the exposed portions are cut surfaces of the cuboidal metal blocks formed by cutting the cuboidal metal blocks.

10. The coil device according to claim 9, wherein the first and second conductive portions are semicircular in cross-section.

11. The coil device according to claim 10, wherein the remaining conductive portions of the second plurality of conductive portions are circular in cross-section.

12. The coil device according to claim 11, wherein the remaining conductive portions of the second plurality of conductive portions are metal pins.

13. The coil device according to claim 2, wherein the second plurality of conductive portions are located on the back surface of the element body and have a rectangular cross-section.

14. The coil device according to claim 1, further comprising a magnetic body disposed in the helical coil.

15. An electronic device including the coil of claim 2, wherein the helical coil includes conductive connecting portions which connect pins of the first plurality of conductive portions to the conductive portions of the second plurality of conductive portions, the conductive connecting portions being located on the end surface of the element body.

16. An electronic device including the coil device of claim 1 and a circuit substrate, the coil device being mounted on the circuit substrate through the back surface or the end surface of the element body.

17. The electronic device of claim 16, wherein the electronic device further comprises a coil antenna provided to be magnetically coupled with the helical coil of the coil device used as an antenna.

18. An electronic device comprising:
a circuit substrate having a plurality of conductors arranged in parallel; and
a plate-like surface mount type component mounted on the circuit substrate and having a mount surface facing the circuit substrate, wherein
the surface mount type component comprises a plurality of semi-ring-shaped conductors arranged in a parallel direction of the plurality of conductors on the circuit substrate and connected to the plurality of conductors on the circuit substrate, to constitute a coil device having a helical coil, and
in each of the plurality of semi-ring-shaped conductors of the surface mount type component, a portion distant from the mount surface is comprised of a metal pin.

19. The electronic device of claim 18, wherein the electronic device further comprises a coil antenna provided to be magnetically coupled with the helical coil of the coil device used as an antenna.
